(19) United States
(12) Patent Application Publication
(10) Pub. No.: US 2016/0328988 A1
(43) Pub. Date: Nov. 10, 2016

(54) DETECTING THE MOOD OF A GROUP

(71) Applicant: INTERNATIONAL BUSINESS MACHINES CORPORATION, Armonk, NY (US)

(72) Inventors: Dario Gil, Katonah, NY (US); David O. Melville, New York, NY (US); Valentina Salapura, Chappaqua, NY (US)

(21) Appl. No.: 14/744,775

(22) Filed: Jun. 19, 2015

Related U.S. Application Data
(63) Continuation of application No. 14/707,888, filed on May 8, 2015.

(51) Int. Cl. G09B 19/00; G10L 25/63; G09B 7/00

(52) U.S. Cl. CPC G09B 19/00; G09B 7/00; G10L 25/63

(57) ABSTRACT

A system and method are provided. The method includes receiving, by a processor-based mood estimator, communications made by members of a group or representations of the communications. The method further includes estimating, by the processor-based mood estimator, a mood of the group based on a graph analysis of the communications made by the members of the group or the representations of the communications.

### CROSS-REFERENCE TO RELATED APPLICATIONS

This application is a Continuation application of co-pending U.S. patent application Ser. No. 14/707,888 filed on May 8, 2015 incorporated herein by reference in its entirety.

### BACKGROUND

1. Technical Field

The present invention relates generally to cognitive processing and, in particular, to detecting the mood of a group.

2. Description of the Related Art

Determining when a group of people is within a satisfactory mood, or when the group mood worsens or improves is advantageous in an enterprise environment for several reasons. First, the level of dissatisfaction of a group can be detected to be increasing, so that corrective actions can be automatically triggered before further escalation. Examples of applications are multiple: determination of group's mood for example in a meeting, and detection when the mood is worsening can be indicator that corrective actions need to be taken, such as adding a short break, or adjustment of the direction the meeting is taking by a facilitator, or commitment to further corrective actions. Another exemplary application is within a group meeting when one, or two or more persons are identified as negative mood outliers which might trigger a conflict and worsen overall group's mood. Another example is mood worsening detection between a group of passengers or a group of people waiting for a service. Once a warning level is reached, corrective actions such as including more agents, providing free coffee or other mood improving action can be triggered before the escalation. Each of these aspects of the problem can result in serious problems for an enterprise in maintaining productivity and effectiveness among its employees in meeting overarching business objectives.

### SUMMARY

According to an aspect of the present principles, a method is provided. The method includes receiving, by a processor-based mood estimator, communications made by members of a group or representations of the communications. The method further includes estimating, by the processor-based mood estimator, a mood of the group based on a graph analysis of the communications made by the members of the group or the representations of the communications.

According to another aspect of the present principles, a system is provided. The system includes a processor-based mood estimator for receiving communications made by members of a group or representations of the communications, and estimating a mood of the group based on a graph analysis of the communications made by the members of the group or the representations of the communications.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary processing system 100 to which the present principles may be applied, in accordance with an embodiment of the present principles;

FIG. 2 shows an exemplary system 200 for estimating the mood of a group, in accordance with an embodiment of the present principles;

FIG. 3 shows an exemplary method 300 for detecting the mood of a group of individuals, in accordance with an embodiment of the present principles.

FIGS. 4-5 show an exemplary method 400 for identifying mood changers, in accordance with an embodiment of the present principles;

FIG. 6 shows an exemplary cloud computing node 610, in accordance with an embodiment of the present principles;

FIG. 7 shows an exemplary cloud computing environment 750, in accordance with an embodiment of the present principles; and

FIG. 8 shows exemplary abstraction model layers, in accordance with an embodiment of the present principles.

### DETAILED DESCRIPTION OF PREFERRED EMBODIMENTS

The present principles are directed to detecting the mood of a group.

The present principles can be implemented, for example, in any of a system and a method. The group can be, for example, attendants in a meeting, or a group of people in a limited space such as at a gate in the airport, in a public office, and so forth. The concept of a group as used herein is not limited to the preceding.

In an embodiment, the group mood can be represented as a quantitative value. In an embodiment, the group mood can represent the likelihood that group members are satisfied, and the probability that the level of satisfaction will go up. The group's mood can be measured in terms of the cognitive state of attendees. Additionally, outliers of the overall group mood, as very positive or negative compared to the overall group mood, can be identified. In an embodiment, a determination of mood may be made automatically and action triggered based on the determined mood. In an embodiment, the estimated mood can be communicated to a meeting facilitator or supervisor or other control system(s) in order to take preventative/corrective actions.

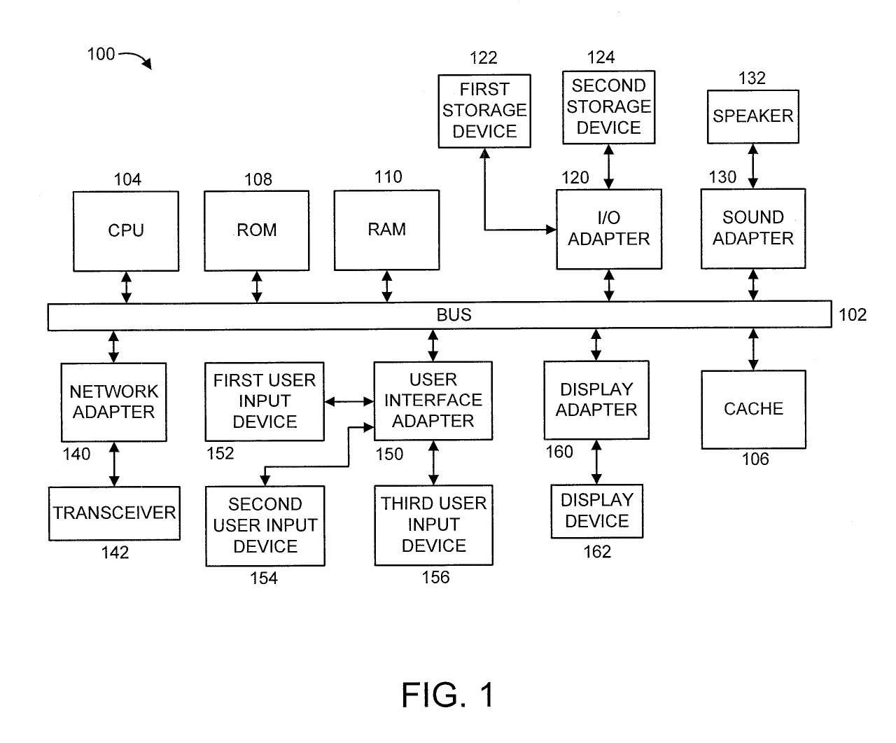

FIG. 1 shows an exemplary processing system 100 to which the present principles may be applied, in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

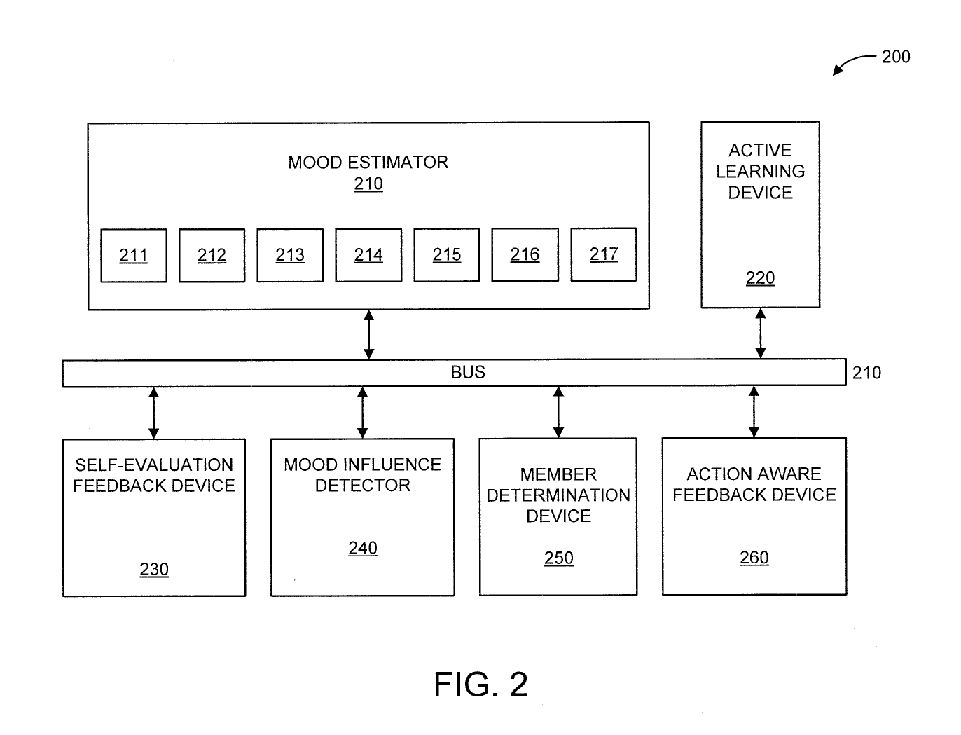

Moreover, it is to be appreciated that system 200 described below with respect to FIG. 2 is a system for implementing respective embodiments of the present principles. Part or all of processing system 100 may be implemented in one or more of the elements of system 200.

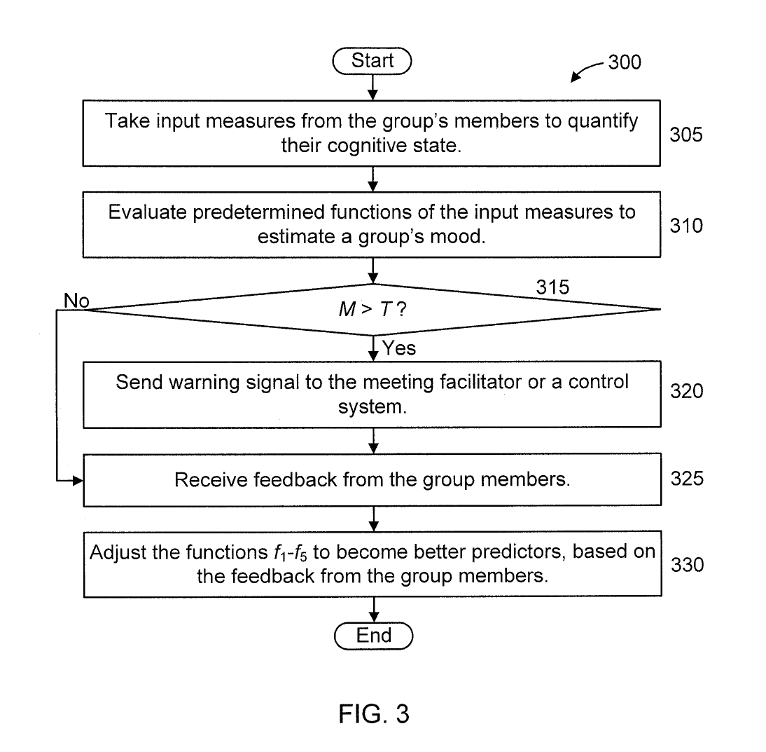

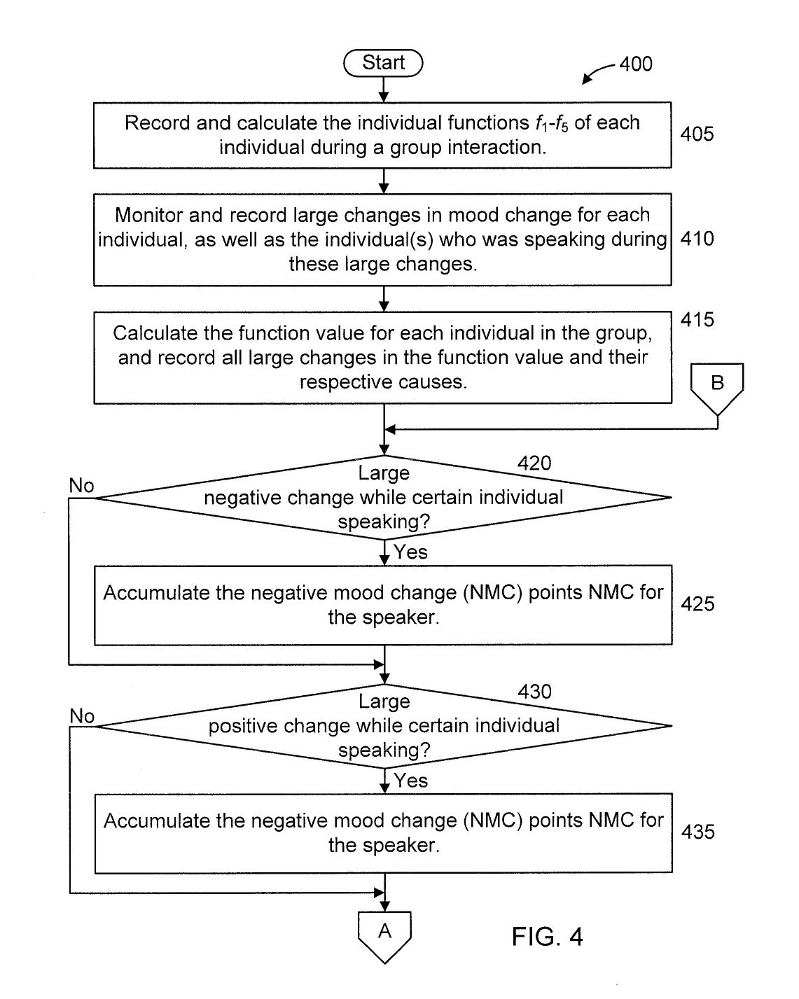

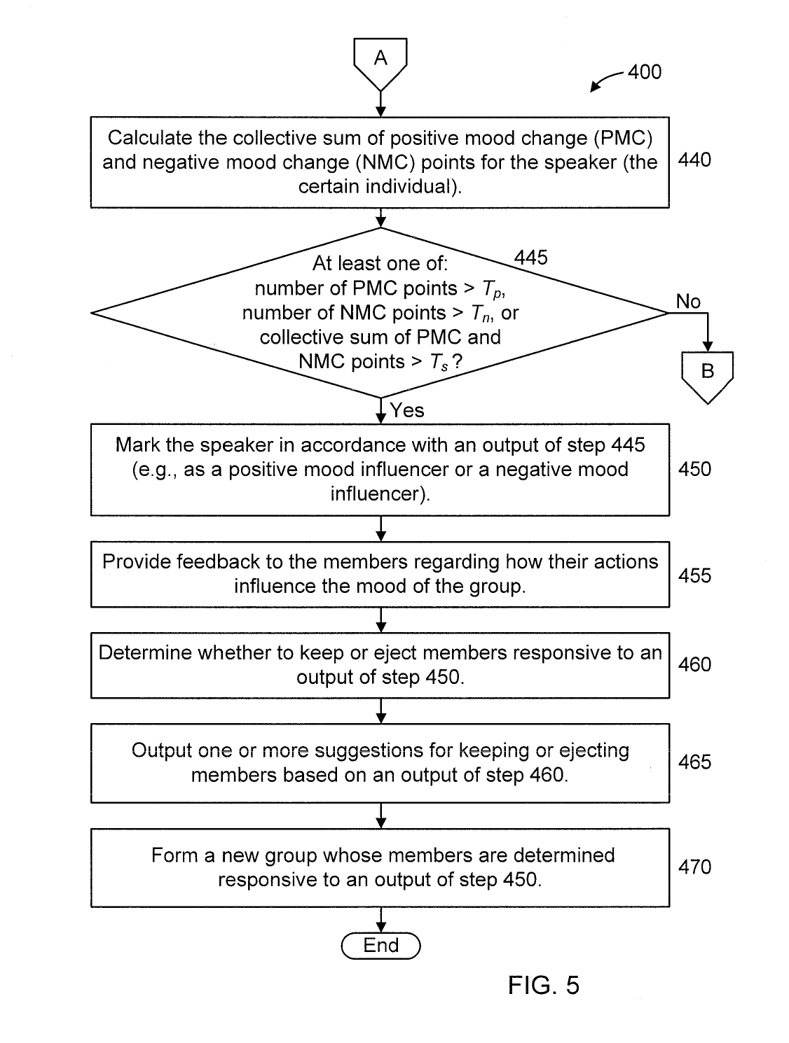

Further, it is to be appreciated that processing system 100 may perform at least part of the method described herein including, for example, at least part of method 300 of FIG. 3 and/or at least part of method 400 of FIGS. 4-5. Similarly, part or all of system 200 may be used to perform at least part of method 300 of FIG. 3 and/or at least part of method 400 of FIGS. 4-5.

FIG. 2 shows an exemplary system 200 for estimating the mood of a group, in accordance with an embodiment of the present principles.

While the following description is provided with respect to a group and its members, the present principles are not limited to the same. For example, the present principles can be used with respect to individuals who are simply present (e.g., in a meeting, a room or other location, and so forth) but not necessarily members of a group in order to use the results provided by the present principles to form groups in the first place. Moreover, the present principles can be used eject members of a group that is already formed or inject new members into a group that is already formed. These and other applications of the present principles are readily determined by one of ordinary skill in the art given the teachings of the present principles provided herein, while maintaining the spirit of the present principles.

The system 200 includes a processor-based mood estimator 210, an active learning device 220, a self-evaluation feedback device 230, the mood influence detector 240, a member determination device 250, and an action aware feedback device 260.

The processor-based mood estimator 210 receives inputs (also referred to herein as “input measures”) for quantifying the cognitive state of members of a group.

The inputs can include, for example, one or more of the following: communications; speech activity; representations of the communications; focus of attention; and physiological measures (e.g., pupil dilation, skin conductance); or analysis of gestures and facial expressions, and so forth. The communications can be made by, and be in between, members of the group (or group member candidates) or can be representations thereof (e.g., transcripts, network topologies of word traversals). For example, the inputs can include a measure of each member's communications using network analysis to determine a network topology of word traversals for a given member. Alternatively or in addition, the inputs can include a measure of the group's communications using network analysis to determine a network topology of word traversals for the group.

Hence, in the embodiment of FIG. 2, the processor-based mood estimator 210 includes a microphone 211, a speech recognition system 212 (for, e.g., generating transcripts), a gaze tracking device 213, a network analyzer 214, a video camera 216, and a video stream analyzer 217. The video camera 216 and the video stream analyzer 217 can be used to detect gestures and facial expressions. In other embodiments, the inputs can simply be provided to the system 200, in which case one or more of the microphone 211, the speech recognition system 212, the gaze tracking device 213, the network analyzer 214, the video camera 216, and the video stream analyzer 217 can be omitted depending upon the specific implementation.

The processor-based mood estimator 210 further includes a function evaluator 215 for evaluating functions of the input measures in order to estimate the mood of the group.

Consider the following designations for the input measures described above: a measure of speech activity (S); a measure of focus of attention (A); a measure of each member's speech/text graph using network analysis to determine a network topology of word traversals (content independent analysis; I); a measure of the group's speech/text graph using network analysis to determine a network topology of word traversals of the group (content independent analysis; G); and physiological measures of the members (e.g., pupil dilation, skin conductance, etc.; H). Speech activity (S) can include actual speech or a representation thereof (e.g., a transcript). In an embodiment, the group's mood can be estimated using the following equation: M=ƒ₁(S)+ƒ₂(A)+ƒ₃(I)+ƒ₄(G)+ƒ₅(H). In an embodiment, a subset of the input measures (e.g., a preselected subset or all that can be obtained which may be less than all that are listed) can be used, whereby an abbreviated version of the preceding formula can be used.

The active learning device 220 performs active learning on the inputs and the functions to learn how the inputs affect the mood of the group.

The self-evaluation mood feedback device 230 receives feedback from the group members regarding their mood.

Outputs from the active learning device 220 and the self-evaluation mood feedback device 230 are provided to the processor-based mood estimator 210 for use in adjusting the functions to estimate the mood of the group and/or refine an estimate of the mood of the group.

The mood influence detector 240 detects positive mood influencers and negative mood influencers from among the members of the group. In an embodiment, the mood influence detector 240 accumulates positive mood change points for positive mood changes and negative mood change points for negative mood changes, and compares at least one of the positive mood change points and the negative mood change points and a sum thereof to at least one corresponding threshold. For example, different thresholds can be used for comparison against the positive mood change points, the negative mood change points, and the sum of the positive and negative mood change points.

The member determination device 250 can determine whether to keep or reject (eject) any members of the group responsive to an output from the mood influence detector 240. The member determination device 250 can form a new group whose members are determined responsive to an output from the mood influence detector 240.

The action aware feedback device 260 provides feedback to members on how their actions affect the mood of the group.

In the embodiment shown in FIG. 2, the elements thereof are interconnected by a bus 201. However, in other embodiments, other types of connections can also be used. Moreover, in an embodiment, at least one of the elements of system 200 is processor-based. Further, while one or more elements may be shown as separate elements, in other embodiments, these elements can be combined as one element. The converse is also applicable, where while one or more elements may be part of another element, in other embodiments, the one or more elements may be implemented as standalone elements. These and other variations of the elements of system 200 are readily determined by one of ordinary skill in the art, given the teachings of the present principles provided herein, while maintaining the spirit of the present principles.

FIG. 3 shows an exemplary method 300 for detecting the mood of a group of individuals, in accordance with an embodiment of the present principles.

At step 305, take input measures from the group's members to quantify their cognitive state. These measures can include one or more of the following: a measure of speech activity (S); a measure of focus of attention determined by gaze tracking devices and/or video cameras and a video stream analyzer in a room (A); a measure of each individual's speech/text graph using network analysis to determine a network topology of word traversals (content independent analysis; I); a measure of a group's speech/text graph using network analysis to determine a network topology of word traversals of the group (content independent analysis; G); and physiological measures of meeting participants (e.g., pupil dilation, skin conductance, etc.; H). Of course, some of the preceding measures can also involve a speech recognition system to initially convert a user's utterances into a transcript that can then be analyzed by a network analyzer.

At step 310, evaluate predetermined functions of the input measures to estimate a group's mood. In an embodiment, the group's mood can be estimated using the following equation: M=ƒ₁(S)+ƒ₂(A)+ƒ₃(I)+ƒ₄(G)+ƒ₅(H). In an embodiment, functions ƒ₁-ƒ₅ can involve, for example, different thresholds to determine the value of each component function, where each component function captures the characteristic of the group. For example, the function ƒ₁(S) quantifies the level of speech activity within the group, and can range from complete stillness and long pauses of the group, to a moderate discussion one or more persons are taking turns in speaking, to an engaged or excited discussion of one or more members to the group, and to shouting and yelling of multiple persons within the group. In an embodiment, this function is implemented as a fuzzy function. Other functions are also possible. That is, the present principles are not limited to the preceding functions, which are merely illustrative and, thus, other functions can also be used in accordance with the teachings of the present principles, while maintaining the spirit of the present principles.

In graph theory, networks are composed of two components: nodes (points in the network), and edges (connecting two nodes together). Connectedness of each node to the network can be used to analyze networks of human relationships, where individuals are represented by nodes in a network, and relationships between them are presented by edges. Each individual's speech activity is represented as an edge in the graph. The sum of all edges from a single individual defines a network topology of word traversals from that individual. All edges from all members of a group determine a network topology of word traversals from the group. The used graphs can be directed or undirected, where the notion of “directedness” is used to differentiate the relationship between two individuals. A directed edge between two nodes can indicate that one individual addresses another relatively more than vice versa.

Network analysis and machine learning techniques provide the capability of having the individual and group interactions affect the estimation of the groups mood estimation (e.g.: ƒ₃(I) and ƒ₃(G)) and associated event triggers. For example, speech transcription being used to estimate individual moods can then through machine learning techniques, lead to an expectation for how that mood effects other individuals in the group, given levels and type of involvement indicated through speech transcription

The functions are defined and/or otherwise configured to take into account the cognitive state of a group relative to one or more of the measures taken at step 305. For example, referring back to the example involving the speech activity of the group, complete stillness and long pauses can be correlated to boredom and so forth, while shouting and yelling can be correlated to moods/cognitive states such as, for example, anger, frustration, and so forth. Regarding the measure of focus of attention, looking around without focus can be correlated to moods/cognitive states such as, for example, disinterest, and so forth. Regarding the physiological measures of meeting participants, sweating and related activities can be correlated to moods/cognitive states such as, for example, nervousness and so forth. In these ways, for example, the measures can be used by the functions to quantify the mood(s) of a group.

In an embodiment, functions can also include time or space based derivatives of the measures, for example, ƒ(S)=k₀S+kt₁ dS/dt+ks₀ dS/ds. Additionally the cross-derivative of space and time can be used to understand migration of mood factors as the result of events, e.g., including of the term kts₁ ddS/(dtds). The detection of temporal and spatial shifts in the mood of a group can allow for event generation that focuses on mitigating or reinforcing such shifts.

Event triggers can be derived from thresholds on individual terms, or triggers can be derived from machine-learning techniques using a combination of the individual terms and training data for given event situations.

At step 315, determine whether or not M exceeds a threshold T. If so, then the method proceeds to step 320. Otherwise, the method proceeds to step 325.

At step 320, send warning signal to the meeting facilitator or a control system.

At step 325, receive feedback from the group members, i.e., their self-evaluation of the group's estimated mood.

At step 330, adjust the functions ƒ₁-ƒ₅ to become better predictors, based on the feedback from the group members.

The individual model for each meeting attendee can be further refined to adjust functions ƒ₁-ƒ₅ above according to each individual group member. Individual values of these specific functions ƒ₁-ƒ₅ for each member are used to identify large differences within a group, that is, outliers. In an embodiment, the group members can be asked for feedback to describe their own mood, and to adjust individual mood description functions. For example, for the functions listed above, the participants can be asked for their own impression of their interaction such as, for example, where they happy, calm, sad, content, or if they were quiet, animated, angry, fighting, sarcastic, and so forth in their exchange with other members of the group (for example, for the function ƒ₁(S)). If there is a difference between the function's output and participant's response, the function is adjusted. In an embodiment, one possible adjustment is to modify the ranges of individual fuzzy sets. Other function modifications are also possible.

FIG. 4 shows an exemplary method 400 for identifying mood changers, in accordance with an embodiment of the present principles.

At step 405, record and calculate the individual functions ƒ₁-ƒ₅ of each individual during a group interaction.

At step 410, monitor and record large changes in mood change for each individual, as well as the individual(s) who was speaking during these large changes. Changes can be evaluated against a threshold to identify large changes.

At step 415, calculate the function value for each individual in the group, and record all large changes in the function value and their respective causes.

At step 420, determine whether or not a large negative change was recorded for several group members while a certain individual was speaking. If so, then the method proceeds to step 425. Otherwise, the method proceeds to step 430.

At step 425, accumulate the negative mood change (NMC) points for the speaker (the certain individual).

At step 430, determine whether or not a large positive change was recorded for several group members while a certain individual was speaking. If so, then the method proceeds to step 435. Otherwise, the method proceeds to step 420.

At step 435, accumulate positive mood change (PMC) points for the speaker (the certain individual).

At step 440, calculate the collective sum of positive mood change (PMC) and negative mood change (NMC) points for the speaker (the certain individual).

At step 445, determine whether or not at least one of: the number of PMC points for a person is greater than a threshold Tₚ, the number of NMC points for a person is greater than a threshold Tₙ, or the collective sum of PMC and NMC points for a person is greater than a threshold Tₛ. If so, then the method proceeds to step 450. Otherwise, the method returns to step 420.

At step 450, mark the speaker (the certain individual) in accordance with an output of step 445. For example, mark the speaker (the certain individual): as a positive mood influencer if the number of PMC points >Tₚ; as a negative mood influencer if the number of NMC points >Tₙ; or as a mood influencer if the collective sum of PMC and NMC points >Tₛ.

At step 455, provide feedback to the members regarding how their actions influence the mood of the group.

At step 460, determine whether to keep or eject any members of the group responsive to an output of step 450. For example, individuals deemed positive mood influencers (i.e., whose PMC points >Tₚ) can be kept, while individuals deemed negative mood influencers (i.e., whose NMC points >Tₙ) are ejected.

At step 465, output one or more suggestions for keeping or ejecting members based on an output of step 460.

At step 470, form a new group whose members are determined responsive to an output of step 450. For example, individuals deemed positive mood influencers can be included in the new group, while individuals deemed negative mood influencers can be excluded from the new group.

Thus, in an embodiment, the NMC points can be compared to a threshold Tₙ to identify an individual that causes large negative mood changes. Such an individual can be avoided for invitations in future projects due to being obstructive and decreasing the productivity of group members.

In an embodiment, the PMC points can be compared to a threshold Tₚ to identify an individual that causes large positive mood changes. Such an individual can be targeted for invitations in future projects due to being positive and increasing the productivity of group members.

Thus, a mood influencer of the group can be identified as a person who caused the groups mood to worsen or to improve. In a group meeting embodiment, this knowledge can be used for automated new member injection (aNMI) or automated member rejection (aMR) to boost productivity of meetings, or to decrease risk of meeting inefficiency, and mood worsening. This information can be also used for selecting future project members. For example, a person who caused the group mood to worsen will be avoided for inclusion in future projects with the same or similar group, if possible.

Group mood, as it relates to social dynamics, may be determined in part by cognitive assessment of body language, degree of interaction, and so forth.

In an embodiment, a feedback mechanism can be included to allow someone to understand how their actions affect the mood of others.

A description will now be given regarding some of the many advantages of the present principles over the prior art.

One advantage is that the present principles quantitatively measure a group members' mood based on objective measures of attendee cognitive states, and a learned function of these states.

Another advantage is that the present principles incorporate individual models of each meeting attendee to further refine functions ƒ₁-ƒ₅ above according to a user. With each model then functions ƒ₁-ƒ₅ are expressed with additional subscripts denoting each meeting attendee's specific function.

Yet another advantage is that the present principles detecting negative influencers or positive influencers in the group. In this way, negative influences can be avoided for inclusion in group functions, and positive influencers can be targeted for inclusion in group functions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

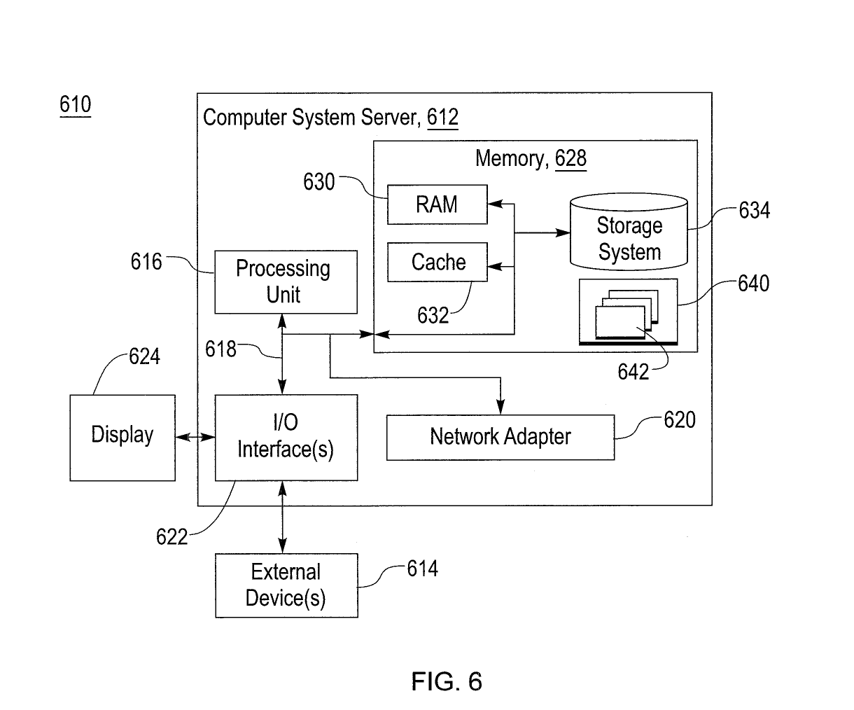

Referring now to FIG. 6, a schematic of an example of a cloud computing node 610 is shown. Cloud computing node 610 is only one example of a suitable cloud computing node and is not intended to suggest any limitation as to the scope of use or functionality of embodiments of the invention described herein. Regardless, cloud computing node 610 is capable of being implemented and/or performing any of the functionality set forth hereinabove.

In cloud computing node 610 there is a computer system/server 612, which is operational with numerous other general purpose or special purpose computing system environments or configurations. Examples of well-known computing systems, environments, and/or configurations that may be suitable for use with computer system/server 612 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 612 may be described in the general context of computer system executable instructions, such as program modules, being executed by a computer system. Generally, program modules may include routines, programs, objects, components, logic, data structures, and so on that perform particular tasks or implement particular abstract data types. Computer system/server 612 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 612 in cloud computing node 610 is shown in the form of a general-purpose computing device. The components of computer system/server 612 may include, but are not limited to, one or more processors or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 612 typically includes a variety of computer system readable media. Such media may be any available media that is accessible by computer system/server 612, and it includes both volatile and non-volatile media, removable and non-removable media.

System memory 628 can include computer system readable media in the form of volatile memory, such as random access memory (RAM) 630 and/or cache memory 632. Computer system/server 612 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the invention.

Program/utility 640, having a set (at least one) of program modules 642, may be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 642 generally carry out the functions and/or methodologies of embodiments of the invention as described herein.

Computer system/server 612 may also communicate with one or more external devices 614 such as a keyboard, a pointing device, a display 624, etc.; one or more devices that enable a user to interact with computer system/server 612; and/or any devices (e.g., network card, modem, etc.) that enable computer system/server 612 to communicate with one or more other computing devices. Such communication can occur via Input/Output (I/O) interfaces 622. Still yet, computer system/server 612 can communicate with one or more networks such as a local area network (LAN), a general wide area network (WAN), and/or a public network (e.g., the Internet) via network adapter 620. As depicted, network adapter 620 communicates with the other components of computer system/server 612 via bus 618. It should be understood that although not shown, other hardware and/or software components could be used in conjunction with computer system/server 612. Examples, include, but are not limited to: microcode, device drivers, redundant processing units, external disk drive arrays, RAID systems, tape drives, and data archival storage systems, etc.

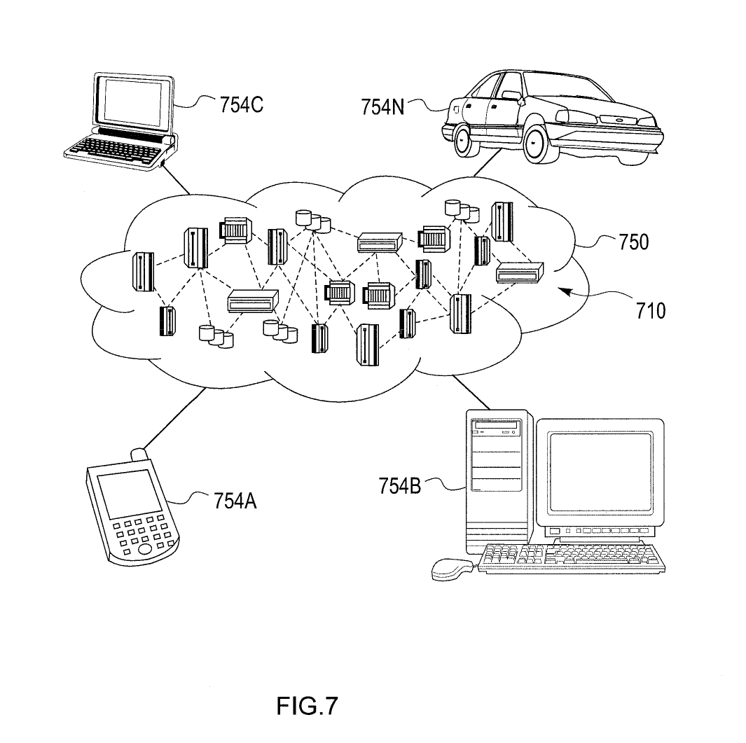

Referring now to FIG. 7, illustrative cloud computing environment 750 is depicted. As shown, cloud computing environment 750 comprises one or more cloud computing nodes 710 with which local computing devices used by cloud consumers, such as, for example, personal digital assistant (PDA) or cellular telephone 754A, desktop computer 754B, laptop computer 754C, and/or automobile computer system 754N may communicate. Nodes 710 may communicate with one another. They may be grouped (not shown) physically or virtually, in one or more networks, such as Private, Community, Public, or Hybrid clouds as described hereinabove, or a combination thereof. This allows cloud computing environment 750 to offer infrastructure, platforms and/or software as services for which a cloud consumer does not need to maintain resources on a local computing device. It is understood that the types of computing devices 754A-N shown in FIG. 7 are intended to be illustrative only and that computing nodes 710 and cloud computing environment 750 can communicate with any type of computerized device over any type of network and/or network addressable connection (e.g., using a web browser).

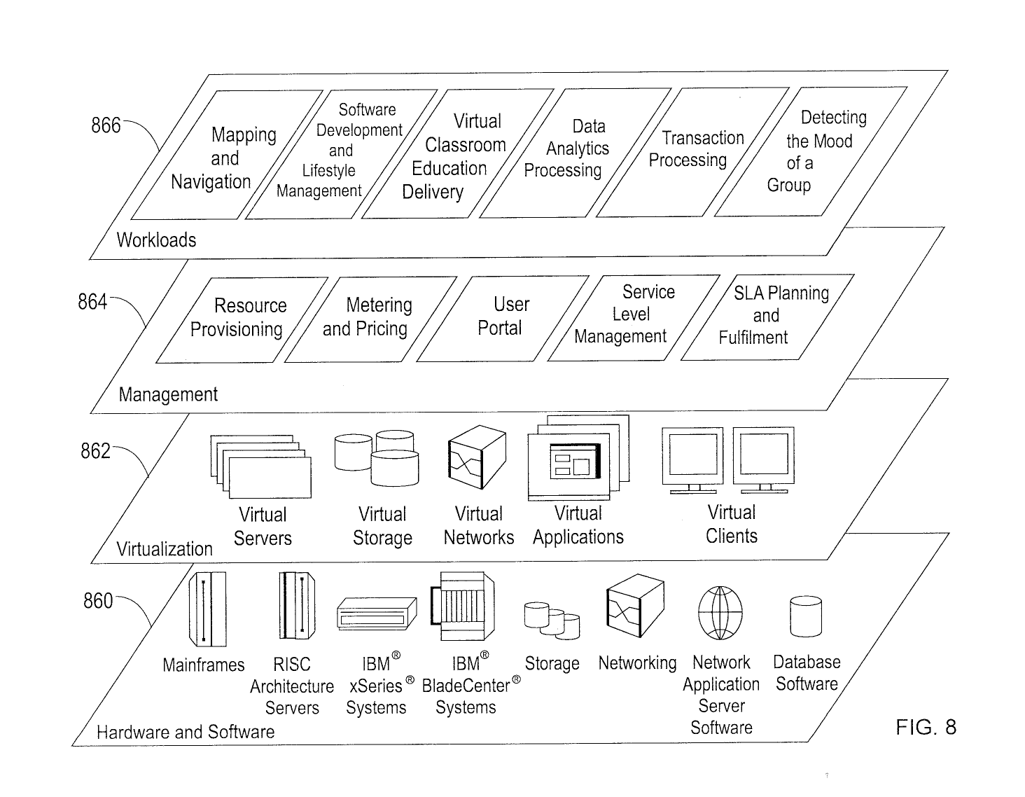

Referring now to FIG. 8, a set of functional abstraction layers provided by cloud computing environment 750 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 860 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 862 provides an abstraction layer from which the following examples of virtual entities may be provided: virtual servers; virtual storage; virtual networks, including virtual private networks; virtual applications and operating systems; and virtual clients.

In one example, management layer 864 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 866 provides examples of functionality for which the cloud computing environment may be utilized. Examples of workloads and functions which may be provided from this layer include: mapping and navigation; software development and lifecycle management; virtual classroom education delivery; data analytics processing; transaction processing; and detecting the mood of a group.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method, comprising:
receiving, by a processor-based mood estimator, communications made by members of a group or representations of the communications; and
estimating, by the processor-based mood estimator, a mood of the group based on a graph analysis of the communications made by the members of the group or the representations of the communications.

2. The method of claim 1, wherein said estimating step estimates the mood of the group further based on physiological measures of the members of the group.

3. The method of claim 1, wherein said estimating step estimates the mood of the group further based on member focus of attention.

4. The method of claim 1, wherein the graph analysis comprises determining a network topology of word traversals.

5. The method of claim 1, further comprising adjusting weighting functions for estimating the mood of the group using active learning and feedback provided from the members of the group, the feedback regarding member self-evaluations of the mood of the group.

6. The method of claim 1, further comprising detecting at least one of positive mood influencers and negative mood influencers from among the members of the group.

7. The method of claim 6, wherein said detecting step comprises:
accumulating positive mood change points for positive mood changes and negative mood change points for negative mood changes; and
comparing at least one of the positive mood change points and the negative mood change points and a sum thereof to at least one corresponding threshold.

8. The method of claim 6, further comprising determining whether to keep or eject at least one of the members of the group responsive to a result of said detecting step.

9. The method of claim 6, further comprising forming a new group whose members are determined responsive to a result of said detecting step.

10. The method of claim 1, further comprising providing feedback to at least one of the members on how their actions affect the mood of the group.

11. The method of claim 1, wherein the communications comprise speech or transcripts of the speech.
